(19) United States
(12) Patent Application Publication
(10) Pub. No.: US 2013/0215484 A1
(43) Pub. Date: Aug. 22, 2013

(54) HOLOGRAM DISPLAY MODULE AND STEREOSCOPIC DISPLAY DEVICE

(71) Applicants: Yasuhiro Takaki, Tokyo (JP); Takashi Kurokawa, Tokyo (JP)

(72) Inventors: Yasuhiro Takaki, Tokyo (JP); Takashi Kurokawa, Tokyo (JP)

(73) Assignee: Tokyo University of Agriculture and Technology National University Corporation, Fuchu-shi, Tokyo (JP)

(21) Appl. No.: 13/818,970

(22) PCT Filed: Aug. 25, 2011
(86) PCT No.: PCT/JP2011/069226

§ 371 Date: May 8, 2013

(30) Foreign Application Priority Data
Aug. 25, 2010 (JP) 2010-187721

(51) Int. Cl. G03H 1/22

(52) U.S. Cl. CPC G03H 1/2294
USPC 359/11

(57) ABSTRACT

A hologram display module 100 that a large number of light source elements and a large number of spatial light modulation elements overlapped with the light source elements are arranged: wherein the light source element is arranged quadratically in area of predetermined height width to comprise each of scanline forming a line in height direction; openings of the light source elements are placed each other in distinct position horizontally; the light source elements produce lights that are coherence spatially each other, respectively; the spatial light modulation element spatially modulates light from the light source element for independence, respectively.

### FIELD OF THE INVENTION

The present invention relates to a hologram display module which does not have mechanical moving part and displays wide viewing angle and which provides a screen of wide viewing angle. Specifically, the present invention relates to a hologram display module comprising a light source element array placed quadratically emitting coherent light each other and a spatial light modulation element array to modulate light of each light source element. Also, the present invention relates to three-dimensional display device that a plurality of hologram display module is placed in length and breadth specifically.

### BACKGROUND ART

As a hologram display technology, a technique to display interference-fringe using a spatial light modulator SLM is known conventionally. For example, an interference-fringe I of which a fringe spacing is order of the wavelength of light is displayed by a SLM 81 of a hologram display device 8 shown in FIG. 17. Because a laser beam LB is irradiated the interference-fringe I with, a regeneration wave X occurs. And a three-dimensional image is reproduced theoretically by eyes E of an observer. The SLM 81 is an optical device giving spatial modulation for incident light. The SLM 81 can control an amplitude of light, a phase of light or the amplitude of light and the phase based on electrical input information appropriately.

However, the SLM 81 having resolution (pixel pitch) of order of the wavelength (1 μm order) of light does not really exist. Thus, any hologram display device using the SLM 81 is not really provided. Alternatively, the SLM 81 is usually comprised of liquid crystal. A thickness of the liquid crystal layer has to be at least 3 μm. Thus, realization of SLM 81 comprised of liquid crystal that pixel pitch is small is technically difficult.

If a pixel pitch is extended in a 2-dimensional display device conventionally, a screen size is extended. On the other hand, interference-fringe I is used in hologram display device. Therefore pixel pitch of the SLM 81 must be almost wavelength of light when the screen size is extended (1 μm order). Thus, the SLM 81 requires enormous quantitative pixel when the screen size is extended.

A hologram display device of FIG. 17 performs the Fresnel type hologram display.

In this hologram display device, a viewing angle of three-dimensional image is determined by the pixel pitch of the SLM 81, and the screen size is determined by a number of the pixel. A viewing angle is represented by the next formula. p is a pixel pitch, and λ is wavelength of laser beam.

2 sin−1(λ/(2p))

N*M is the number of the pixel. The screen size becomes N*p*M*p. For example, viewing angle of hologram image is 30 degrees and screen size of hologram image is supposed to be 20 inches. The pixel pitch of this hologram image is approximately 1 μm (0.97 μm), and the SLM 81 of the number of 421,000*316,000 pixel is required. As mentioned earlier, it is technically extremely difficult in nature to manufacture the SLM having the number of enormous pixel in super high-definition.

### PRIOR ART DOCUMENTS

### Patent Document

[Patent Document 1]

Japanese Patent Laid-Open No. 20,010-8822

[Non-Patent Document]

[Non-Patent Document 1]

S. A. Benton, Applications of Holography and Optical Data Processing, 401-409 (1977).

### DISCLOSURE OF THE INVENTION

### Problem to be Solved by the Invention

As a technique to solve such an inconvenience, a patent document 1, a non-patent document 2 (horizontal parallax type hologram: HPO are known. Because a vertical parallax is waived in these techniques, a high horizontal resolution is kept. In other words, an advantages of these techniques is that horizontal resolution is high enough, because vertical parallax was sacrificed. However, life of device is easy to shorten because mirror drive part has rolling mechanism in these techniques. An optical system is complicated and, in these techniques, the system occupies large space, besides. Thus, it is impossible to comprise thin display (flat panel type display device) using the techniques.

An object of the invention is to provide a three-dimensional display techniques for hologram which have no mechanical moveable portion and which have wide viewing angle.

### Means to Solve the Problem

A subject matter of a hologram display module of the present invention is (1)-(12).

(1) hologram display module that a large number of light source elements and a large number of spatial light modulation elements overlapped with the light source elements are arranged:

wherein the light source element is arranged quadratically in area of predetermined height width to comprise each of scanline forming a line in height direction;

openings of the light source elements are placed each other in distinct position horizontally;

the light source elements produce lights that are coherence spatially each other, respectively;

the spatial light modulation element spatially modulates light from the light source element for independence, respectively.

According to the present invention, a resolution of horizontal parallax is secured because a vertical parallax is waived.

(a) A formation area of the spatial light modulation elements and a formation area of light source elements are thereby secured.

(b) The hologram data can be generated in a short time without using expensive processor because computational complexity of hologram data decreases considerably. Also, a three-dimensional image can be displayed in real time by hologram because there become few burdens of data transmission. As the light source element used for hologram display module of the present invention, the self luminescence light source is preferable. Also, the light source elements may be comprised of the coherent light sources and mask which transmission pattern (pinholes and slits)was formed. The lights from the coherent light sources are irradiated the mask with, and the lights from the mask are emitted through the pinholes and the slits.

(2)

The hologram display module according to claim 1 comprising:

an array comprising a plurality of light source elements generating light coherent spatially each other, and

an array comprising a plurality of spatial light modulation elements to modulate spatially lights from a plurality of light source elements for independence, respectively;

wherein

a scanline is comprised of a plurality of lines placed predetermined number N in coarser regular interval d2 vertically sequentially, and each line is comprised of a plurality of light source elements located in regular interval d1 horizontally,

the light source elements of a certain line and the light source elements of any other line are arranged in regular interval (horizontal pitch p) (=d1/N) finely horizontally to be able to slip each other,

the spatial light modulation elements are placed to arrangement of the light source elements.

For example, in the present invention, the light source elements and the spatial light modulation elements are placed in slanted line pattern, zigzag pattern, cross-woven lattice pattern or others.

(3) The hologram display module according to claim 2,

wherein light source elements on Line k (k=2, 3, . . . , N) and light source elements on Line (k−1) are arranged in the regular interval (horizontal pitch p) dense horizontally each other to slip off (=d1/N).

the light source elements on Line k (k=2,3, . . . , N) and the light source elements on line (k−1) are arranged in regular interval (horizontal pitch p) (=d1/N) finely horizontally to be able to slip each other. In this case, the light source elements and the spatial light modulation elements become slanted line pattern.

(4) The hologram display module according to claim 1,

wherein each of the spatial light modulation element modulates a phase and/or an amplitude of each light from the light source elements.

(5) The hologram display module according to claim 1,

the array comprising a plurality of light source elements coherent spatially is comprised of a shading mask which pinhole pattern or slit pattern was formed, and coherent light from a single transverse mode laser light source is irradiated the shading mask with.

(6) The hologram display module according to claim 1,

wherein light from the single transverse mode laser light source is irradiated the shading mask with through optical fiber (or fibers).

(7) The hologram display module according to claim 6,

wherein the single transverse mode laser light source is shared with at least one of the other hologram display module.

(8) A hologram display module according to one either of claims 5-7:

wherein the single transverse mode laser light source is comprised of a plurality of laser light sources which luminous color is different mutually; and

wherein each of filters corresponding to luminous color of the laser light sources is formed by pattern
that filter area of one color appears in one scanline, or
that filter area of each color appears in one scanline repeatedly.

(9) A hologram display module according to one either of claims 5-8:

wherein the coherent light from single transverse mode laser light source is converted into parallel beam through lens; and

wherein the parallel beam is irradiated array comprising a plurality of light source elements with.

(10) A hologram display module according to claim 9:

wherein each of the spatial light modulation elements modulates an amplitude of light from the light source elements,

incidence angle to the light source elements of the parallel beam is slanted to array side (not perpendicular).

(11) A hologram display module according to claim 9:

when the single transverse mode laser light source is comprised of a plurality of laser light sources which luminous color is different mutually,

an incidence angle to the light source element of the parallel beam inclines only angle corresponding to light of wavelength that is shortest among light of a plurality of colors to the light source element array surface.

(12) A hologram display module according to claim 2:

wherein the array comprising a plurality of light source element coherent spatially is comprised by a surface emitting laser array having a Talbot resonator.

(13) A hologram display module according to claim 12:

wherein the surface emitting laser array is comprised of a plurality of surface emitting lasers which luminous color is different mutually; and

wherein each of the surface emitting lasers is formed by pattern
that surface emitting lasers area of one color appears in one scanline, or
that surface emitting lasers area of each color appears in one scanline repeatedly.

(14) A hologram display module according to claim 2:

wherein perpendicular diffuser plate scattering light in response to each hologram scanline in vertical direction is comprised on the array comprising the spatial light modulation element;

wherein the perpendicular diffuser plate is comprised of a cylindrical lens array (lenticular board) and a shading mask having horizontal slits provided with an emission side of the cylindrical lens;

wherein the perpendicular diffuser plate is comprised of an unidirectional holographic diffuser and a shading mask having horizontal slits provided with an emission side of the cylindrical lens.

(15) A three-dimensional display device comprising a plurality of hologram display module described in either of claims 1-13,

wherein a display screen placed in vertical direction and/or horizontal direction is comprised.

By the three-dimensional display device of the present invention, a difference of emission of light position due to slits forming a line in vertical direction can be canceled, and vertical viewing angle can be extended.

### Effect of the Invention

According to the present invention, production of hologram display module that there is not Mechanical moving part and viewing angle is wide is enabled, and production of large-scale and thin hologram three-dimensional display device is enabled. In module for the hologram display of the present invention, the light source elements and the spatial light modulation elements are arranged in one scanline finely horizontally, but the pitch of spatial light modulation elements is kept in large value. Thus, the spatial light modulation part is manufactured easily. As for a light source element, a self luminescence element, e.g., a surface emitting lasers may be used. In this case, a heat interference between light source elements can be prevented, and a pitch between light source elements can be kept in large value.

The three-dimensional display device of the present invention can display still image and moving image. Also, the three-dimensional display device of the present invention can display monochromatic image and color image. According to the present invention, vertical parallax is not calculated. Thus, computational complexity of hologram data extremely decreases. The production cost of device thereby falls because expensive part is not used for operation resources (microprocessors, others).

### BRIEF DESCRIPTION OF DRAWINGS

[FIG. 1]

FIG. 1 is an illustration which shows a first embodiment of a three-dimensional display device of the present invention.

[FIG. 2]

FIG. 2 is explanatory drawing of an embodiment to irradiate shading mask with laser beam through optical fiber and lens from laser light source, FIG. 2 (A) is a figure which watched a hologram display module from the side, FIG. 2 (B) is a plan view in the same way.

[FIG. 3]

FIG. 3 is figure which shows example of a perpendicular diffuser plate.

[FIG. 4]

FIG. 4 is other explanatory drawing of a module for a hologram display in a first embodiment. One laser light source is used in common by 3 unit of module for the hologram display, and, in FIG. 4. A laser beam is irradiated shading a mask with through optical fibers and lenses.

[FIG. 5]

FIG. 5 is figure showing a hologram display module substituted by a hologram display module of FIG. 2. FIG. 5 (A) is a figure showing an example to irradiate with a laser beam to a shading mask through lenses from laser light source. FIG. 5 (B) is a figure showing an example to irradiate with laser beam to a shading mask directly from laser light source.

[FIG. 6]

FIG. 6 is an illustration which shows principle of a hologram display module.

[FIG. 7]

FIG. 7 is an explanatory drawing of a hologram display module, and a pinhole array is formed on a shading mask.

[FIG. 8]

FIG. 8 is an explanatory drawing of a hologram display module, and a slit array is formed on a shading mask.

[FIG. 9]

FIG. 9 (A) is a figure which watched hologram display module 100 (or 101,102,103) from y direction (cf. white arrow). FIG. 9 (B) is a figure which watched hologram display module 100 (or 101,102,103) from x direction (cf. white arrow).

[FIG. 10]

FIG. 10 is a figure which shows other constitution of module for color hologram display. In FIG. 10, a light source element consists of R-G-B light sources of optical fibers, and a pinhole array or a slit array (in FIG. 10 pinhole array) formed on a shading mask. FIG. 10 (A) is a side view, and FIG. 10 (B) is a plan view in module. FIG. 10 (A) is figure which watched module from the side, and FIG. 10 (B) is plan view in module.

[FIG. 11]

FIG. 11 is a figure showing other constitution of a module for color hologram display. In FIG. 11, a light source element consists of each R-G-B optical fibers (R-G-B light sources) and a pinhole array or a slit array (it is a pinhole array in FIG. 10). In example of FIG. 11 (A), a light from each optical fiber of R-G-B is put together into one optical fiber. One module works by gathered light. In example of FIG. 11 (B), a light from each optical fiber of R-G-B is put together into one optical fiber. This gathered light is supplied to a plurality of a module for color hologram display.

[FIG. 12]

FIG. 12 is a figure showing a color filter (R-G-B filter) used for a module for color hologram display (FIG. 10 or FIG. 11). FIG. 12 (A) is a figure showing a color filter that width of each R-G-B filter element is equal to module width. FIG. 12 (B) is a figure showing a hologram display module which a filter of the same color is not placed on the same scanline.

[FIG. 13]

FIG. 13 is a figure showing another color filter (R-G-B filter) used for a module for color hologram display (FIG. 10 or FIG. 11).

[FIG. 14]

FIG. 14 is explanatory drawing showing second embodiment of three-dimensional display device of the present invention. A coherent light is generated by array of surface emitting laser.

[FIG. 15]

FIG. 15 is a sectional view of a hologram display module (Talbot resonator) used for a three-dimensional display device of second embodiment.

[FIG. 16]

FIG. 16 is a figure which shows constitution of a module for color hologram display of s. In this arrangement, an array of surface emitting lasers having Talbot resonator is used.

[FIG. 17]

FIG. 17 is a figure showing hologram display device (aerial hologram display device) of theoretical Fresnel type.

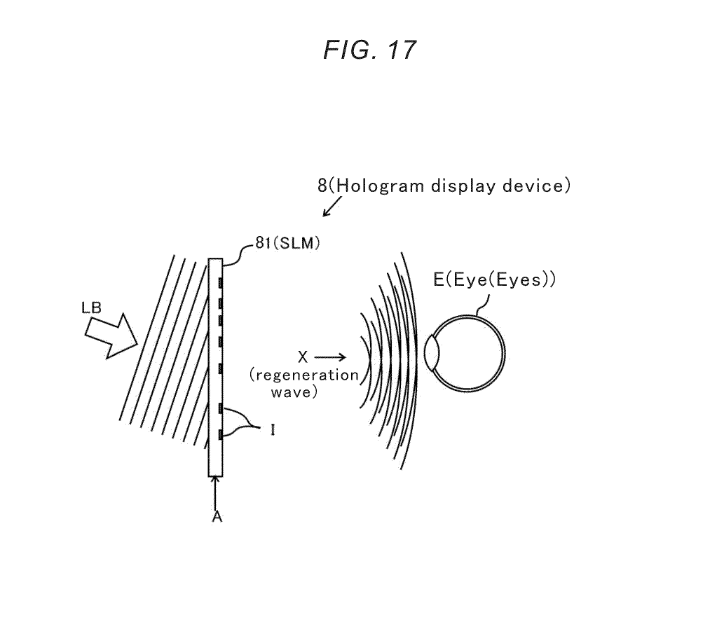

### FORM TO CARRY OUT INVENTION

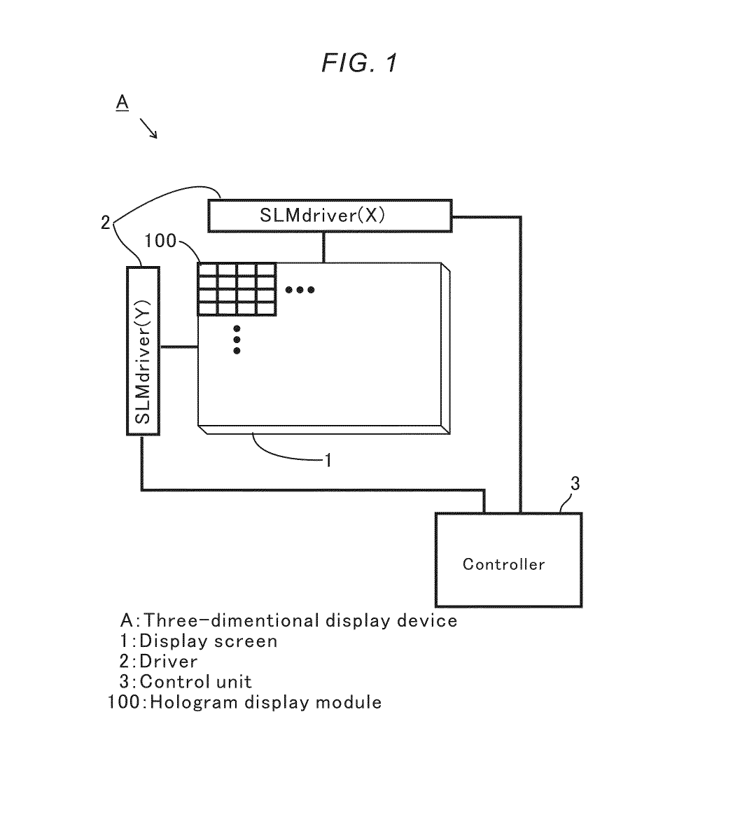

FIG. 1 is an illustration which shows a first embodiment of a three-dimensional display device of the present invention. In FIG. 1, a three-dimensional display device A (hologram device) comprises a display screen 1, a drive 2 and a control unit 3.

The drive 2 drives a spatial light modulation elements SLM to be described below, and the control unit 3 controls the whole of the three⁻dimensional display device A.

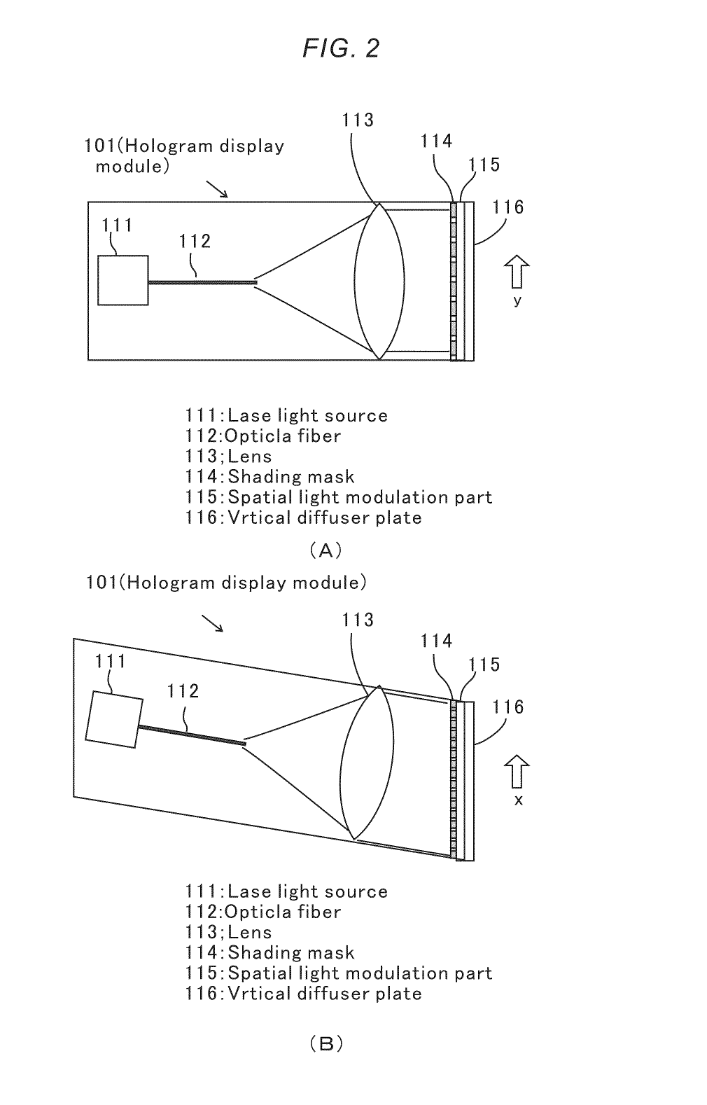

A feature of the three-dimensional display device of the present invention is architecture of the display screen 1. The display screen 1 is comprised of a plurality of hologram display module 100, and these modules 100 are located vertically and horizontally. As shown in FIG. 2 (A), a hologram display module 101 includes a laser light source 111 of single transverse mode.

In the hologram display module 101 of FIG. 2 (A), the light from the laser light source 111 is emitted to a lens 113 for generating parallel beam through an optical fiber 112 of single mode. The light from lens 113 is emitted to the shading mask 114 for generating light source element array. A pattern of pinhole array or a pattern of slit array is formed to the shading mask 114. Thus, the shading mask 114 is the light source element in the present invention. The light emitted from pinholes or slits formed on the shading mask 114 keeps coherent state each other.

The light emitted from a spatial light modulation part 115 is emitted through a vertical diffuser plate 116 to a hologram viewer. The light emitted from the spatial light modulation part 115 is emitted to a viewer.

Holograms can be classified in an amplitude modulation-type, a phase modulation-type and a complex amplitude modulation-type depending on kind of a modulation technique. In the amplitude modulation-type hologram, the spatial light modulation part 115 modulates only the amplitude. In the phase modulation-type hologram, the spatial light modulation part 115 modulates only phase. In the complex amplitude modulation-type hologram, the spatial light modulation part 115 modulates both amplitude and phase. Because primary diffraction image is utilized in amplitude modulation-type hologram, as shown in FIG. 2 (B), an angle of inclination of parallel beam from lens 113 can be set depending on the primary diffraction angle.

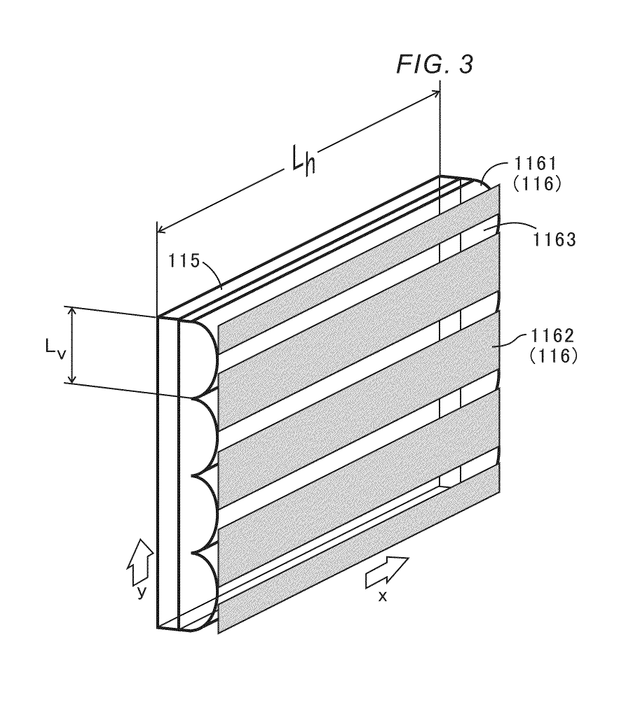

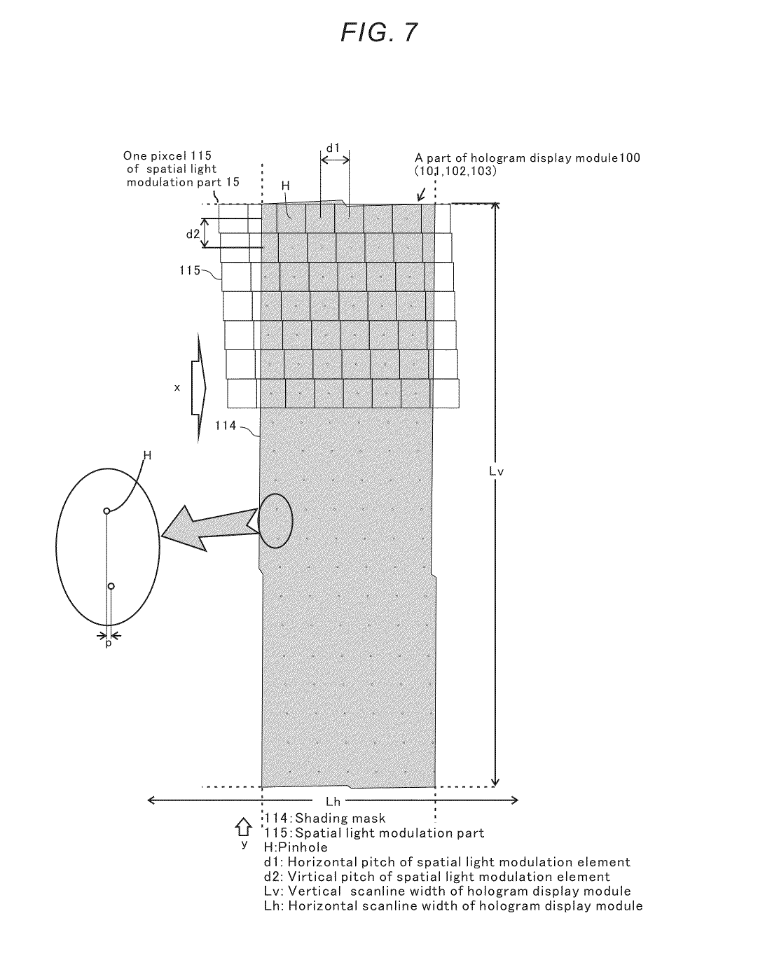

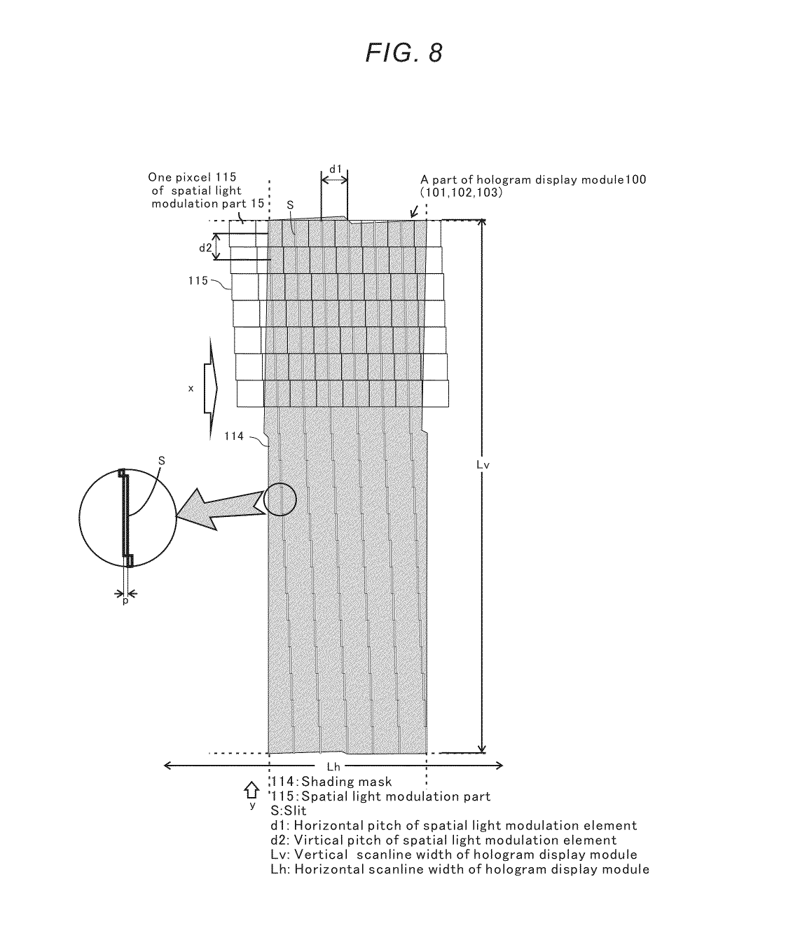

FIG. 3 shows an example of the vertical diffuser plate 116. As shown in FIG. 3, the vertical diffuser plate 116 comprises on an array comprising SLM. In FIG. 3, one cylindrical lens (lenticular board) 1161 is corresponding to one hologram scanline (a vertical scanline width: Lv, a horizontal scanline width: Lh). On a group of the cylindrical lenses 1161, a mask 1162 is comprised. A plurality of slits 1163 are formed to this mask 1162 along lengthwise direction (horizontally) of the cylindrical lenses 1161. Also, in substitution for the cylindrical lens, holographic diffuser can be used. The holographic diffuser has property to scatter light in vertical direction. A plurality of slits S are formed to a shading mask 114 for generating light source element array (it refers to FIG. 2 and FIG. 7, FIG. 8 to be described below). The vertical diffuser plate 116) cancels difference of the vertical position of slits S The vertically oriented view level can be thereby extended.

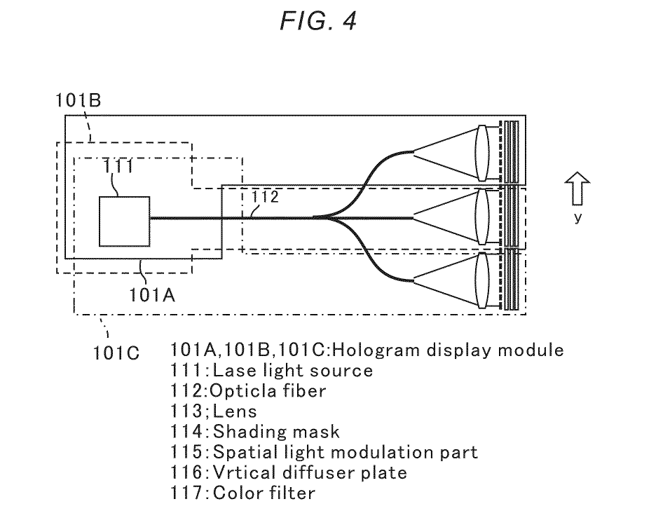

By the explanation, one laser light source was located to one hologram display module. However, a plurality of hologram display modules are arranged quadratically, and the 3-dimensional display device is constructed. In this case, as shown in FIG. 4, the optical fiber 112 attached to one laser light source 111 is branched, for example, into three. The three diverged optical fibers can be connected to the hologram display module 101A, 101B, 101C. A plurality of the hologram display modules 101A, 101B, 101C can thereby share one laser light source 111. By such a constitution, the number of laser light source decreases. Thus, assembling and adjustment of the hologram display module become easy, and the production cost decreases.

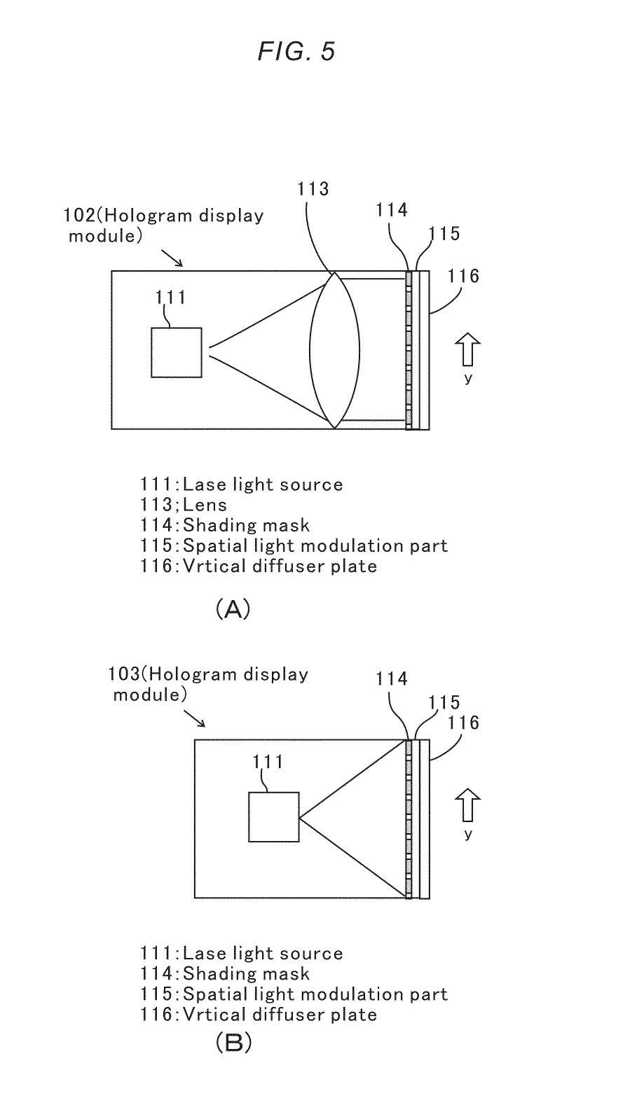

According to the present invention, replacing with the hologram display module 101 of FIG. 2, the hologram display module 102,103 shown in FIG. 5 (A), (B) can be used. In the hologram display module 102 of FIG. 5 (A), the light from the laser light source 111 is irradiated lens 113 with, and a light from the lens 113 is irradiated the shading mask 114 with. In the hologram display module 103 of FIG. 5 (B), a light from the laser light source 111 is irradiated direct the shading mask 114 with.

The interference-fringe information of hologram is optical interference image of an object beam and a reference beam. The object beam is a light diffused on the object or a light reflected by the object. The interference-fringe information can be photographed using a image sensor. Alternatively, an interference-fringe information of hologram is generated by a simulating interference with a computer. The interference-fringe is displayed to a spatial light modulation part 115, and a laser beam is irradiated the spatial light modulation part 115 with. The regeneration wave occurring in this way generates three-dimensional image.

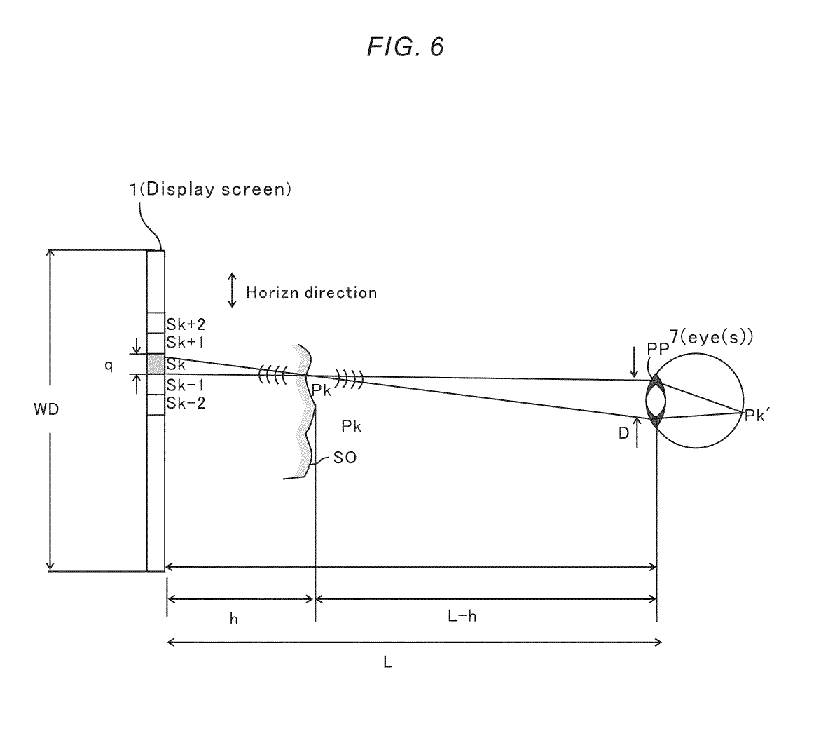

FIG. 6 is an illustration which shows principle of hologram display module 101,102,103. In FIG. 6, a three-dimensional image SO is generated just before display. The maximum distance h between the three-dimensional image SO and the display is about the same with the screen size WD. The maximum distance h is distance that image seems to stand out. Also, the observation distance L is approximately 3 times of the screen size. A large number of spherical waves are emitted by hologram display module to condense light at each point in the three-dimensional image SO. A light from point in three-dimensional image SO similar to light emitted from point on real object, it enters the eyes 7 (eyes) of a viewer. In FIG. 6, a distance display screen 1 and the eyes 7 of a hologram viewer are L, and a diameter of the eyes 7 is D. Also, an image formation position of three-dimensional image is only distance h away from the display screen 1. An diameter q of an area of the display screen 1 projected on the eyes 7 is represented in equation 1.

q=(D*h)/(L−h) (1)

If a horizontal width (a module width or a horizontal width) WD of the hologram display module 100 (FIG. 1), 101 (FIG. 2), 102 (FIG. 5 (A)) or 103 (FIG. 5 (B)) is q or more, for the viewer, enough coherent areas are secured. For example, in the case of “D=5 mm, L=105 cm, h=30 cm”, “q=2 mm” is found by calculation. The size of the hologram display module 100,101,102 or 103 is about 5 mm*5 mm. In this case, a natural hologram display is accomplished.

The spherical wave emitted then by the hologram display module Sk is condensed on point Pk on three-dimensional image. The spherical wave emitted from a point Pk is imaged in point Pk′ on the retina of the eyes 7. If the size of the hologram display module 100, 101, 102 or 103 is larger than the size q determined by the size of the eyes 7 (when a size of the module is about 2q in practice), more natural hologram can be displayed. Note that the lens 113, the shading mask 114, the spatial light modulation part 115 and the vertical diffuser plate 116 can be formed integrally by a glass substrate. The display screens 1 of various kinds of size are provided. The display screen 1 of small size is applied to cell-phone, and the display screen 1 of large size is applied to home television.

FIGS. 7 and 8 show enlarged view of the hologram display modules 100 (cf. FIG. 1), 101 (cf. FIG. 2), 102 (cf. FIGS. 4 (A)) and 103 (cf. FIG. 4 (B)).

In FIG. 7, a pinhole array is formed on a shading mask 114. A plurality of pinholes H comprising a pinhole array are placed vertically and horizontally to form a light source element array. As shown in FIG. 7, a plurality of pinhole H formed to the shading mask 114 are located in (horizontal pitch p) in appointed verticality width area (scanline width Lv) at interval dense horizontally and it is located in interval d2 which is fault in vertical direction. An interval in the horizontal direction of pinholes H is an interval when the pinhole array was watched from direction where the white arrow y in the figure indicates. An interval in the vertical direction of pinholes H is an interval when the pinhole array was watched from direction where the white arrow x in the figure indicates. Note that it is desirable for a diameter of the pinhole H to be the horizontal pitch p or less.

That is, a group of pinholes H on Line 1 (a top line on the scanline width Lv) is formed horizontally in a pitch d1. The vertical interval with a group of pinholes H on Line 2 (the second line from the top on scanline width Lv) and a group of pinholes H of Line 1 is d2. Neighboring hole deviates from the loss. A group of pinholes H on Line 2 (the second line from the top on scanline width Lv) is shifted off a group of pinholes H of Line 1 horizontally. The shifted length horizontal is p=d1/N. Also, a group of pinholes H on Line k (k<=N) is shifted off a group of pinholes H of Line 1 vertically. The shifted length is ((k−1)*d2). The shifted length of the group of the pinholes H on Line k (k<=N) between the group of the pinhole H on Line 1 is (k−1)*p. N is an integer to be decided on the scanline width Lv by the vertical interval d2 (N=Lv/d2.

In the example of sequence of pinhole, in 1 scanline width, sequence of N line shifts by horizontal pitch p sequentially from Line 1. The pinholes sequence from Line 1 to Line N shifts by horizontal pitch p on one scanline width sequentially. However, the pinholes sequence does not have to shift off as above sequentially. That is, the order of N lines slipping off sequentially by horizontal pitch p can be replaced appropriately.

When the N lines on one scanline width are looked at from direction that white arrow y indicates, it is important for any sequence that all pinholes are arranged by a pitch p.

In FIG. 7, the spatial light modulation part 115 is formed on the shading mask 114. In this embodiment, for the spatial light modulation part 115, a liquid crystal panel is used. The size of one pixel (spatial light modulation elementof the spatial light modulation part 115 is d1*d2. For the spatial light modulation part 115, general-purpose liquid crystal panel can be used. The spatial light modulation elements are placed to arrangement of the light source elements. The spatial light modulation part 115 can modulate both phase and amplitude by pixel. Even a phase modulation is enough for the three-dimensional display. The conjugate light is removed easily by the phase modulation. For example, it can be assumed Lv=400 μm, d1, d2=20 μm, p=1 μm, N=20. In this case, the pixel pitch of spatial light modulation part is 20 μm, and the indication of SVGA (800*600 pixel is enabled. The size of the hologram display module is 16 mm*12 mm.

FIG. 8 shows a shading mask 114 which a pattern of slits S) are formed. The operation of the slits S of FIG. 8 is the almost same as the operation of the pinholes H shown in FIG. 7. However, an use efficiency of the slits S becomes higher than an use efficiency of the pinholes H. Note that, it is desirable for a width of the slit to be the horizontal pitch p or less, and it is desirable for a height of the slit to be d2 or less.

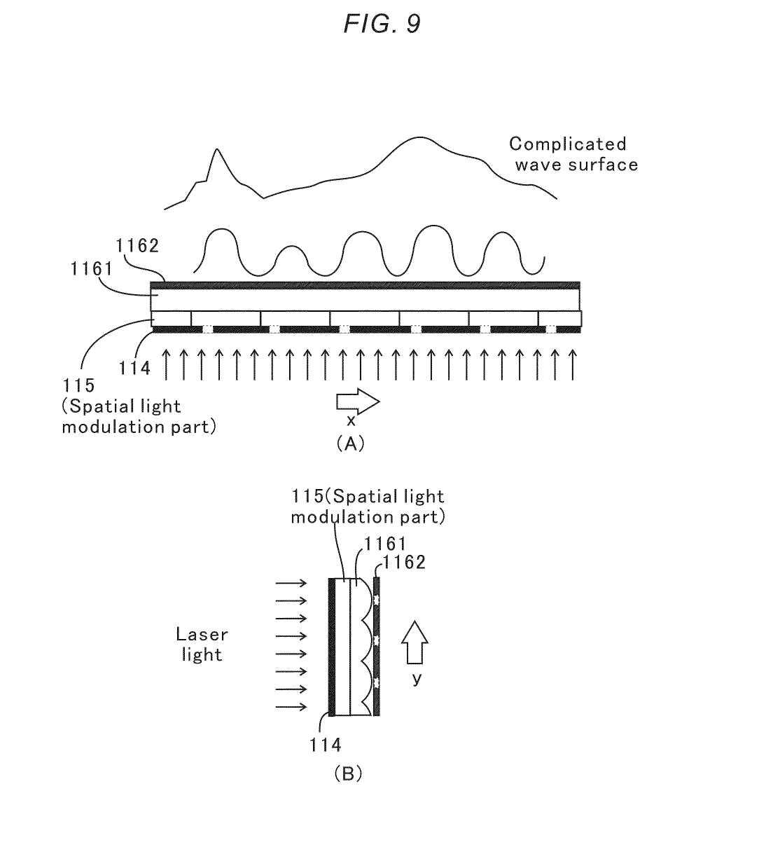

FIG. 9 (A) shows the hologram display module 100 (or 101,102,103) watched from a direction that the white arrow y indicates. In FIG. 9 (A), the N lines on one scanline width is displayed. FIG. 9 (B) shows the hologram display module 100 (or 101,102,103) watched from a direction that the white arrow x indicates. In FIG. 9 (A), the complicated wave surface is reproduced by hologram. According to the present invention, the high-density hologram (1,000/mm or more) can be achieved horizontally. As a result, the three-dimensional display of wide viewing is enabled.

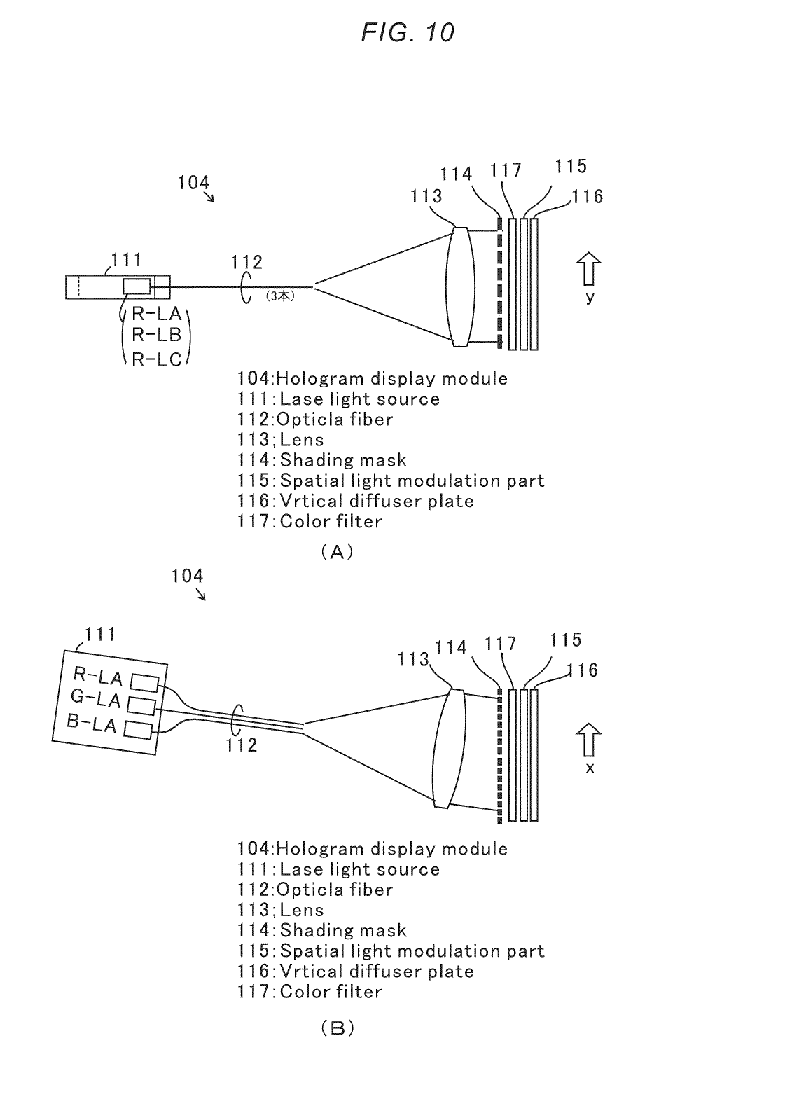

Then, three-dimensional color indication is described. FIG. 10 (A) is a figure showing a constitution of a module for color hologram indication. In the module 104 for color hologram display of FIG. 10 (A), a slit array is used. In FIG. 10 (A), an optical fiber (as shown in 3 optical fiber in a lump code 112 of single mode is connected to three kinds of lasers, respectively. The three kinds of lasers are a laser R-LA oscillating red light, a laser G-LA oscillating mercury green, a laser B-LA oscillating blue glow. The emitting light edges of three optical fibers are summarized in one, the edges gathered up are put in the focus of the lens 113.

Particularly, the lenses 113 are located horizontally (x direction) so that the emitting light becomes parallel beam in the case that the cylindrical lenses are used for the lenses 113. Also, the emitting light edges of the optical fibers 112 are gathered to be very close in single row horizontally, the edges gathered up are put in the focus of the lens 113. The three lights of R-G-B are thereby emitted from the emitting light edges of the optical fibers 112 horizontally. As for the emitted light, it is entered to shading mask 114. The color filter is placed on the incident side or the emitting side (in the figure, on the emitting side) of the spatial light modulation part 115. The constitution of the color filter 117 is described later.

As necessary the vertical diffuser plate 116 (e.g., the diffuser plate shown in FIG. 3 is used) is placed on the back of the spatial light modulation part 115. Note that color filter 117 may be formed integrally with the spatial light modulation part 115. Alternatively, the color filter 117 may be formed integrally with the shading mask 114.

As described earlier, holograms can be classified in an amplitude modulation-type, a phase modulation-type and a complex amplitude modulation-type depending on kind of a modulation technique. As described earlier, in the amplitude modulation-type hologram, the spatial light modulation part 115 modulates only the amplitude, in the phase modulation-type hologram, the spatial light modulation part 115 modulates only phase, in the complex amplitude modulation-type hologram, the spatial light modulation part 115 modulates both amplitude and phase. In the amplitude modulation-type hologram, the primary diffraction image is utilized. Thus, it is preferable for angle of inclination of light from lens 113 to be about the same with the primary diffraction angle. In the color hologram, the angle of the inclination of the light emitted from lens 113 is the same as the primary diffraction angle that is maximum among the primary diffraction angles of each colors as shown in FIG. 10 (B). In the case of R-G-B color hologram, the angle of inclination of the light from lens 113 is set the same as primary diffraction angle of blue light Preferably. Alternatively, three R-G-B lights emitted from three R-G-B optical fibers can be entered at different angle each other to the shading mask 114. Note that the difference of the primary angle of diffraction of each R-G-B color can be embedded in the data when the hologram data are made.

In FIG. 10 (A), three optical fibers are connected to three R-G-B lasers, respectively. The emitting light edges of three optical fibers are summarized in one, the edges gathered up are put in the focus of the lens 113. Also, three R-G-B optical fibers connected to three R-G-B lasers can be gathered up in a single optical fiber. The edge of the single optical fiber can be put in a focus of the lens 113.

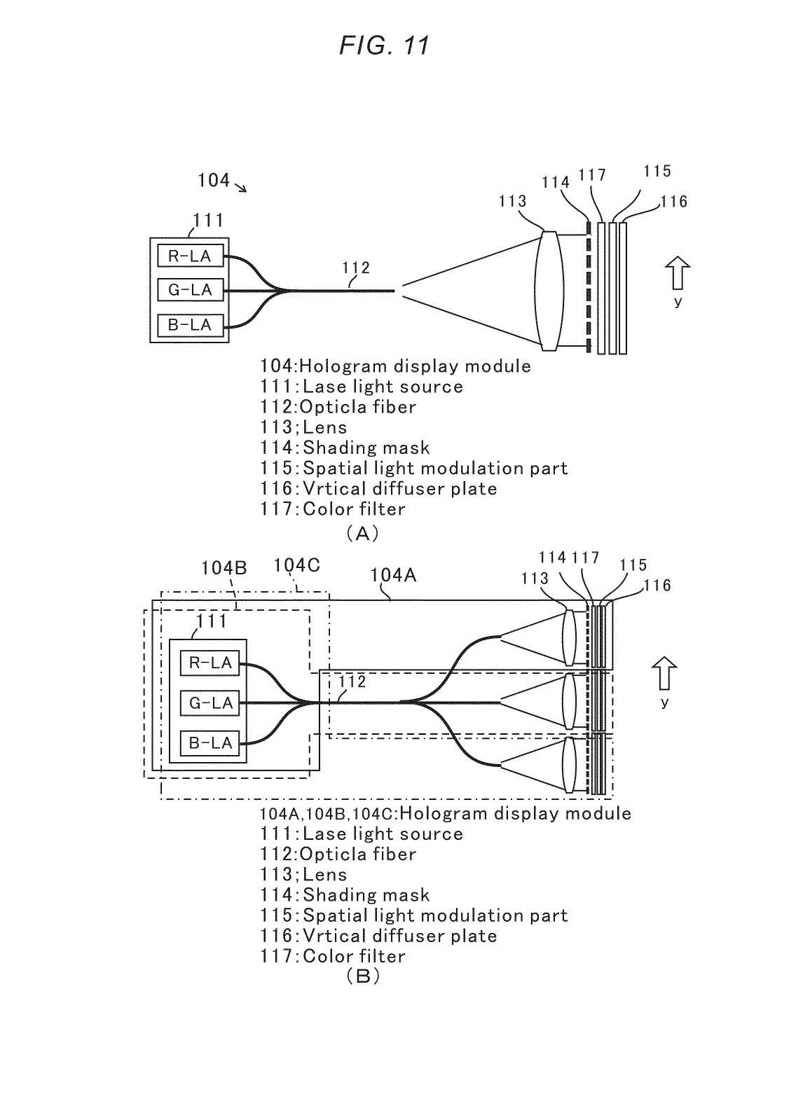

FIG. 11 is a figure which shows other constitution of module for the color hologram display of the present invention. In FIG. 11, the R-G-B optical fibers and the light source elements comprising a pinhole array or a slit array (in FIG. 11 it is a pinhole array) are constructed. In FIG. 11 (A), the lights from R-G-B optical fibers are gathered by one optical fiber, and the gathered light is supplied in one color hologram display module. In FIG. 11 (B), the lights from R-G-B optical fibers are gathered by one optical fiber, and the gathered light is supplied in a plurality of color hologram display modules.

As described earlier, in FIG. 10, the R-G-B laser light source unit 111 (R-LA, G-LA, B-LA) is placed to one module 104 for color hologram display. The optical fiber is drawn out from each laser light source R-LA, G-LA, B-LA. As shown in FIG. 11 (A), the optical fibers drawn out from each laser light source R-LA, G-LA, B-LA are gathered by one optical fiber (as shown in code 112.

Also, in the present invention, the gathered optical fiber (as shown in FIG. 11 (A) code 112 can be branched into plural number (three fibers) as shown in FIG. 11 (B). That is, a plurality of hologram display modules 104 can share one R-G-B laser light source 111. By such a constitution, the number of laser light sources R-LA, G-LA, B-LA can be reduced. Thus, assembling and adjustment of the module for color hologram display become easy, and the production cost decreases.

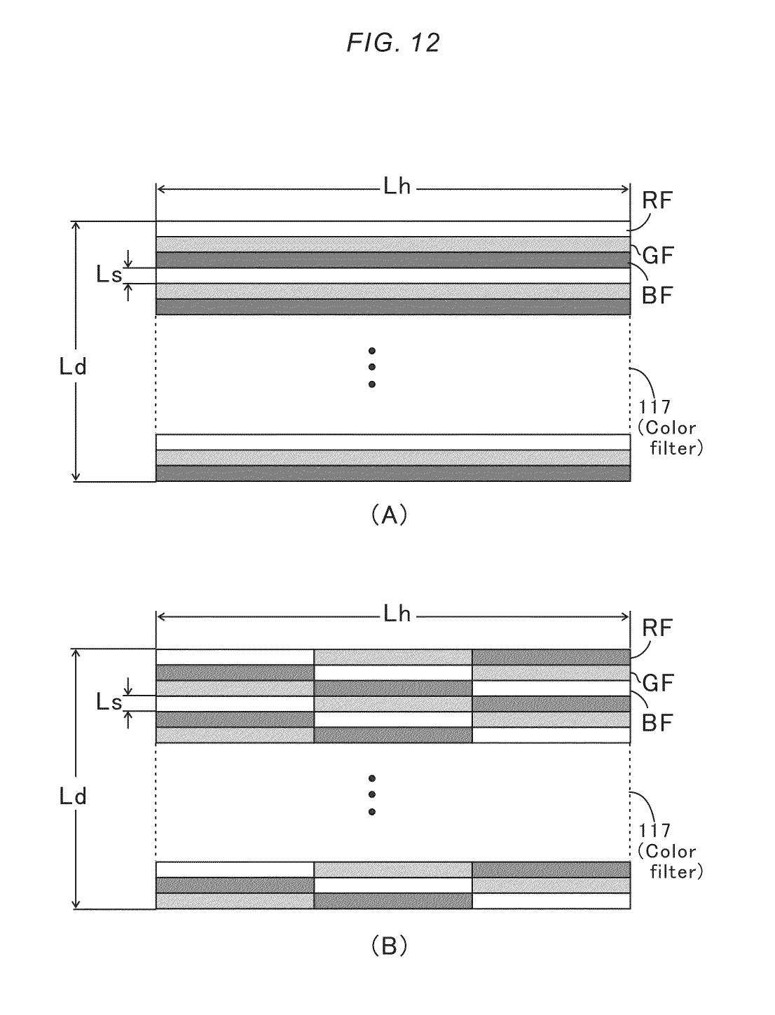

FIG. 12 (A), (B) are figures which showed a placement of the R-G-B color filter 117. The color filter 117 is comprised of a filter element RF penetrating only R light, a filter element GF to penetrate only G light, a filter element BF penetrating only B light. A group of the filter element RF, the filter element GF and the filter element BF are placed consecutively.

In FIG. 12 (A), each horizontal width of filter elements RF, GF, BF is equal to the horizontal width Lh of the module for color hologram display. The perpendicular width of the filter element RF, GF, BF corresponds to the line width of the module for color hologram display. In FIG. 12 (A), the perpendicular width Ls of the filter element (RF, GF or BF) corresponds to the scanline width Lv of the module for monochromatic hologram display. In FIG. 12 (A), the filter elements (RF, GF and BF) are placed by this order repeatedly vertically. The perpendicular width of one module for color hologram display is represented in Ld.

As described earlier, in FIG. 6, a distance display screen 1 and the eyes 7 of a hologram viewer are L, and a diameter of the eyes 7 is D. Also, an image formation position of three-dimensional image is only distance h away from the display screen 1. An diameter q of an area of the display screen 1 projected on the eyes 7 is represented in equation 1.

q=(D*h)/(L−h) (1)

FIG. 12 (B) shows the module for color hologram display that module width Lh is bigger than approximately 2 times (2q) of “A diameter of display screen area represented in an eye”. In this case, as shown in FIG. 12 (B), a horizontal width of the filter elements RF, GF, BF is about 2q. In FIG. 12 (B), a belt-shaped area that perpendicular width is indicated in Ls is the filter elements RF, GF, BF.

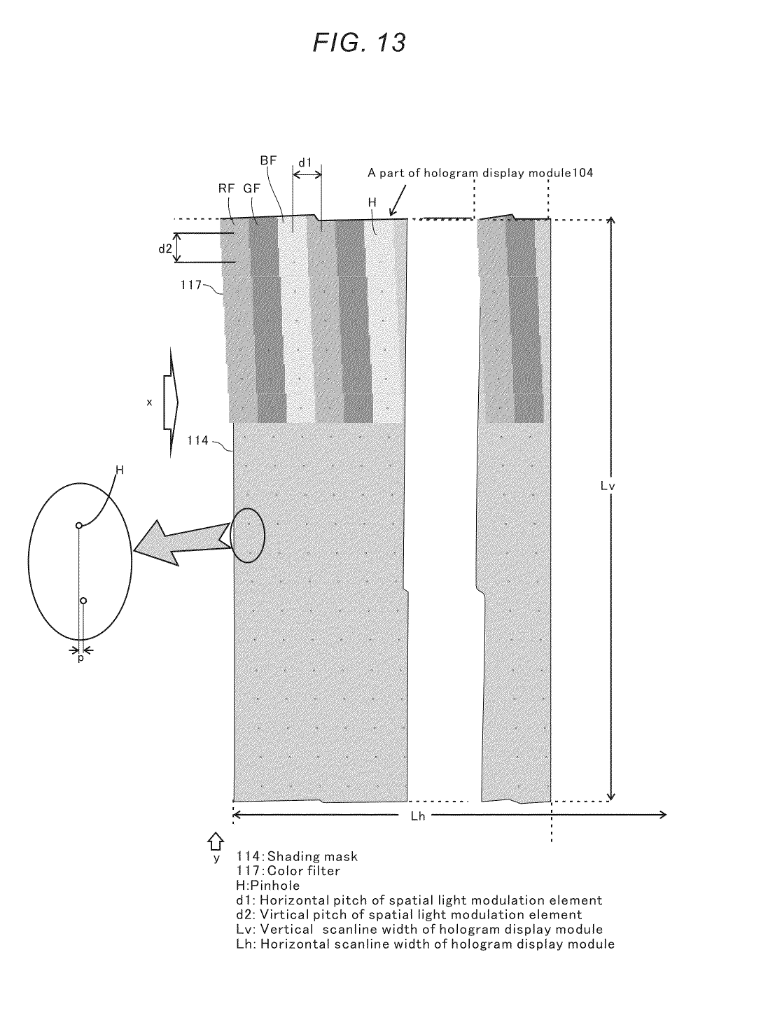

FIG. 13 shows another placement example of the filter elements RF, GF, BF. In this particular example, the pinholes H as the light source elements are placed vertically and horizontally. These pinholes H comprises pinhole array. Because the spatial light modulation elements are arranged corresponding to the light source elements, the horizontal pixel pitch of the spatial light modulation elements is d1, a group of pinholes H on Line 1 (a top line on the scanline width Lv) is formed horizontally in a pitch d1. In this case, corresponding to one line of the spatial light modulation element, the filter elements RF, GF, BF are placed repeatedly sequentially. In other words the horizontal pitch of the filter elements is d1, too. The vertical interval between a group of pinholes H on Line 2 (the second line from the top on scanline width Lv) and a group of pinholes H of Line 1 is d2. A group of pinholes H on Line 2 (the second line from the top on scanline width Lv) is shifted off a group of pinholes H of Line 1 horizontally. The shifted length horizontal is p=d1/N.

The spatial light modulation elements of Line 2 and the filter elements (RF, GF and BF) are arranged corresponding to the light source elements. In each line, the spatial light modulation elements and the filter element (RF, GF and BF) are shifted off sequentially. The shifted length horizontal is p. The sequence (sequence of line) of filter elements are shifted sequentially. In a large number of lines, Line k where the position of filter elements becomes same as the position of Line 1 exists. A group of filter elements from Line 1 to Line k comprises 1 scanline. The display colors of the module for color hologram display were three-color attribute (red (R), green (G), blue (B)). According to the present invention, the other colors can be further added to the colors of R-G-B. Also, depending on applications, a group of colors except a group of lights of R-G-B can be used.

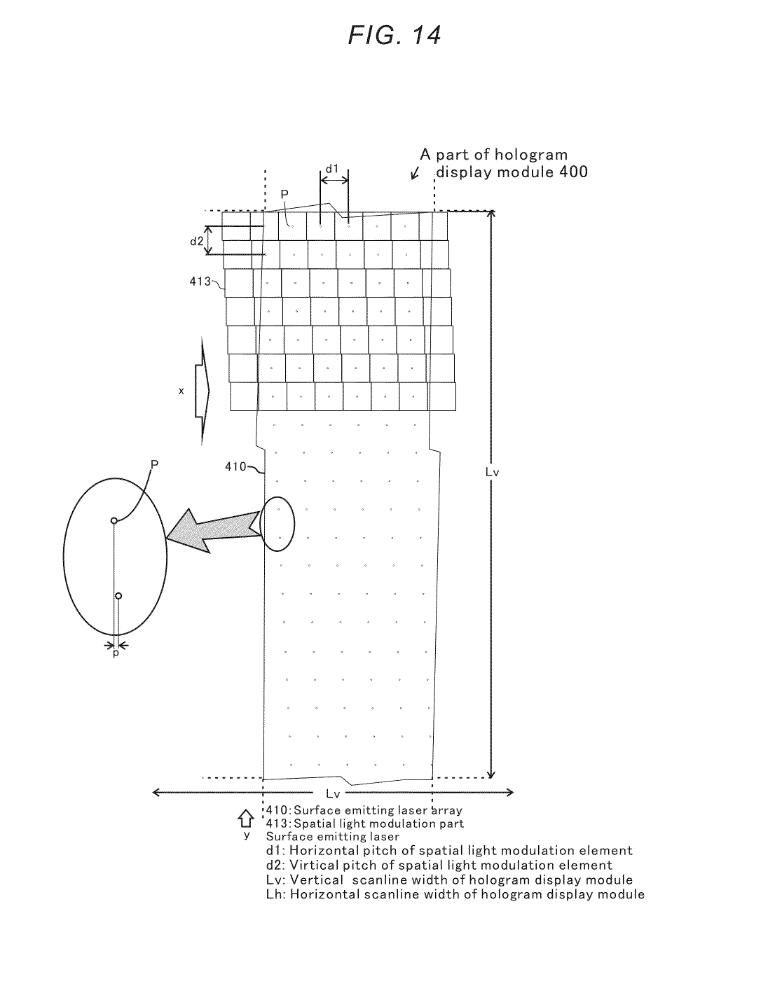

A second embodiment that the light source elements are surface emitting lasers is described below. In the second embodiment, the coherent light is generated by an array of light source elements which are surface emitting lasers. FIG. 14 is a plane view which shows a part of a hologram display module 400. In FIG. 14, a surface emitting laser array is shown. In the surface emitting laser array, the surface emitting laser elements P are placed in verticality and level. The surface emitting laser elements P are placed finely at a constant pitch horizontally, and they are placed coarsely at a constant pitch vertically. Specifically, a pattern of the surface emitting laser array is the same as the pinhole pattern described in FIG. 7. In FIG. 14, the scanline width is Lv, the horizontal size of the spatial light modulation part is d1, the vertically size is d2, the horizontal pitch watched from a direction that the white arrow y indicates is p, and the number of the surface emitting laser elements P in a scanline width is N. Lv, d1, d2, p and N in FIG. 14 are the same as Lv, d1, d2, p and N in FIG. 7, respectively.

As indicated in FIG. 14, the surface emitting laser elements P are located horizontally finely (by a horizontal pitch P in the predetermined height width area (scanline width Lv), and are located vertically coarsely (by a vertical pitch d2) in the same height width area.

Also, in FIG. 14, a spatial light modulation part 413 is formed on the surface emitting laser array. In this embodiment, the liquid crystal panel is used as a spatial light modulation part 115. The size of spatial light modulation part 413 is d1*d2. As the spatial light modulation part 413, a normal liquid crystal panel can be used. The spatial light modulation elements comprising spatial light modulation part 413 are placed to arrangement of the surface emitting laser elements P. Even a phase modulation is enough for the three-dimensional display. The conjugate light is removed easily by the phase modulation.

The lights which each surface emitting laser emits are merely incoherent each other when the surface emitting lasers are arranged quadratically. Thus Talbot resonator is introduced into surface emitting laser array to make coherent light each other.

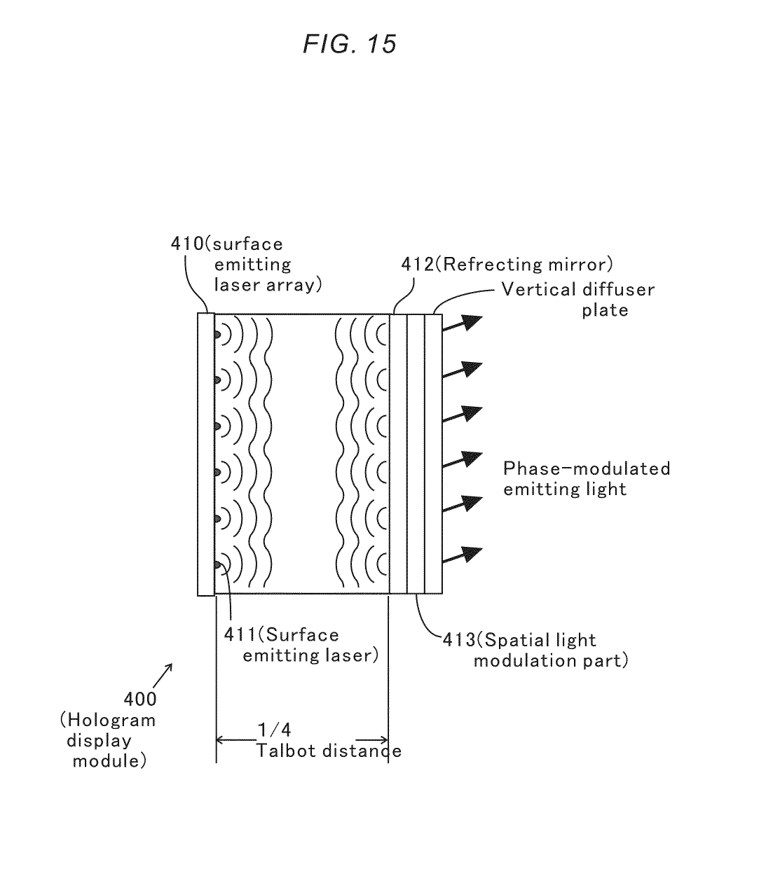

As shown in cross section illustration of FIG. 15, Talbot resonator is incorporated in the module for color hologram display 400 in the present embodiment. The module for color hologram display 400 is comprised of a surface emitting laser array 410, a reflecting mirror 412, and a spatial light modulation part 413. The reflecting mirror 412 is set in a position (e.g., when it was assumed d1=d2=20 μm, approximately 330 μm) of a quarter of Talbot distance. Talbot distance is a distance to image the periodic images by oneself. A constitution of Talbot resonator using the surface emitting laser is well-known. Specifically, Talbot resonator is disclosed in JP2008-124,087 (inventor: Takashi Kurokawa)

A self-image formation occurs because of Talbot-Lau effect on the surface emitting laser array 410. As a result, a phase synchronism by light injection locking between the lasers happens. The uniformity of the oscillation wavelength is good then. Even if the laser beams were low power, the injection to the surface emitting laser array 410 is locked. Image size which is necessary for coherence may be whole size of the hologram display module, or may be even a size of (scanline width)*(2q width) of the hologram display module. q is width of area that enters an eye in the hologram display module which illustrated by FIG. 6.

In the present embodiment, high-density hologram which the horizontal scan lines were formed at 1,000/mm of density is implemented. As a result, the three-dimensional display of a wide viewing angle is enabled. Also, the heat radiation is promoted because the horizontal pitch d1 of the surface emitting laser 411 and the vertical pitch d2 are big. In this embodiment, because the lens system and the beam scanning system are disuse, the manufacture cost of the flat panel is low. Particularly, a thinner display units can be manufactured in the hologram display module of the second embodiment in comparison with the first embodiment. In the module for color hologram display of the second embodiment, the light source emits light by oneself. Thus, the hologram display module of the second embodiment has a higher use efficiency of the light than the first embodiment.

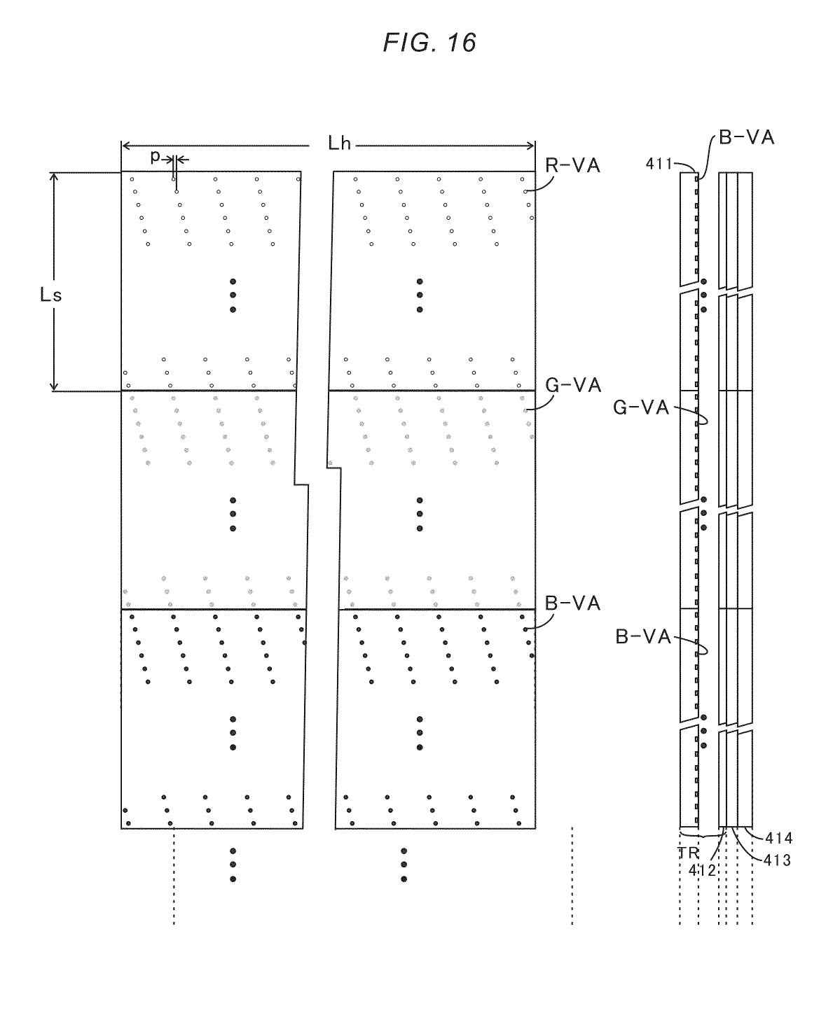

The constitutional example of the three-dimensional color hologram display using the surface emitting laser array is described next. FIG. 16 is a figure which shows a constitution of a module for color hologram display when the surface emitting laser array having Talbot resonator is used. The basic architecture is similar to the constitution of module for monochromic hologram display (FIG. 14). However, in the module for color hologram display of FIG. 16, a surface emitting laser array R-VA emitting red light, a surface emitting laser array G-VA emitting green light and a surface emitting laser array B-VA emitting blue light are located on one substrate. These laser arrays are located in R-VA, G-VA and B-VA on one scanline width alternately.

For example, the red laser beams that the red surface emitting lasers emit placed in one scanline width is coherent. In other words the coherent scanlines of R, G and B are formed alternately. Thus, like case using the color filter, the color hologram display is implemented. Note that, in constitution of FIG. 16, the length of Talbot resonator is the same as wavelength of each R, G or B, respectively. In FIG. 16, a pitch of surface emitting laser array is different by scanline of R-G-B little by little. Thus, a pitch of the spatial light modulation part is similarly different by Color (R, G or B) little by little.

### DENOTATION OF REFERENCE NUMERALS

1 a display screen

2 a driver

3 a control unit

7 eyes

8 a hologram display device

81 SLM

100,101,101A, 101B, 101C, 102,103,104,104A, 104B, 104C a hologram display module

111 a laser light source

112 an optical fiber

113 a lens (lenses)

114 a shading mask

115 spatial light modulation part

116 vertical diffuser plate

117 color filters

400 hologram display module

410 surface emitting laser array

411 surface emitting laser

412 reflecting mirrors

413 spatial light modulation part

1161 cylindrical lens

1162 masks

1163 slits

A three-dimensional display device

E eyes

H pinhole

I interference-fringe

LB laser beam

Laser light source which emits R-LA, G-LA, B-LA R-G-B light

RF, GF, BF color filter element

Surface emitting laser array which emits R-VA, G-VA, B-VA R-G-B light

Lv scanline width

Lh module width (horizontal width)

Ld module length width (vertically oriented width)

P surface emitting laser element

S slit

SO three-dimensional image

X regeneration wave

x, y white arrow

1. hologram display module that a large number of light source elements and a large number of spatial light modulation elements overlapped with the light source elements are arranged:
wherein
the light source element is arranged quadratically in area of predetermined height width to comprise each of scanline forming a line in height direction;
openings of the light source elements are placed each other in distinct position horizontally;
the light source elements produce lights that are coherence spatially each other, respectively;
the spatial light modulation element spatially modulates light from the light source element for independence, respectively.

2. The hologram display module according to claim 1 comprising:
an array comprising a plurality of light source elements generating light coherent spatially each other, and
an array comprising a plurality of spatial light modulation elements to modulate spatially lights from a plurality of light source elements for independence, respectively;
wherein
a scanline is comprised of a plurality of lines placed predetermined number (N) in coarser egular interval (d2) vertically sequentially, and each line is comprised of a plurality of light source elements located in regular interval (d1) horizontally,
the light source elements of a certain line and the light source elements of any other line are arranged in regular interval (horizontal pitch p) (=d1/N) finely horizontally to be able to slip each ohter,
the spatial light modulation elements are placed to arrangement of the light source elements.
For example, in the present invention, the light source elements and the spatial light modulation elements are placed in slanted line pattern, zigzag pattern, cross-woven lattice pattern or others.

3. The hologram display module according to claim 2,
wherein light source element of k line (k=2, 3, . . . , N) and light source element of (k−1) line are arranged in the regular interval (horizontal pitch p) dense horizontally each other to slip off (=d1/N).
the light source elements of k line (k=2, 3, . . . , N) and the light source elements of (k−1) line are arranged in regular interval (horizontal pitch p) (=d1/N) finely horizontally to be able to slip each ohter.
In this case, the light source elements and the spatial light modulation elements become slanted line pattern.

4. The hologram display module according to claim 1,
wherein each of the spatial light modulation element modulates a phase and/or an amplitude of each light from the light source elements.

5. The hologram display module according to claim 1,
the array comprising a plurality of light source elements coherent spatially is comprised of a shading mask which pinhole pattern or slit pattern was formed, and coherent light from a single transverse mode laser light source is irradiated the shading mask with.

6. The hologram display module according to claim 1,
wherein light from the single transverse mode laser light source is irradiated the shading mask with through optical fiber (or fibers).

7. The hologram display module according to claim 6,
wherein the single transverse mode laser light source is shared with at least one of the other hologram display module.

8. A hologram display module according to claim 5:
wherein the single transverse mode laser light source is comprised of a plurality of laser light sources which luminous color is different mutually; and
wherein each of filters corresponding to luminous color of the laser light sources is formed by pattern
that filter area of one color appears in one scanline, or
that filter area of each color appears in one scanline repeatedly.

9. A hologram display module according to claim 5:
wherein the coherent light from single transverse mode laser light source is converted into parallel beam through lens; and
wherein the parallel beam is irradiated array comprising a plurality of light source elements with.

10. A hologram display module according to calim 9:
wherein each of the spatial light modulation elements modulates an amplitude of light from the light source elements,
incidence angle to the light source elements of the parallel beam is slanted to array side (not perpendicular).

11. A hologram display module according to calim 9:
when the single transverse mode laser light source is comprised of a plurality of laser light sources which luminous color is different mutually,
an incidence angle to the light source element of the parallel beam inclines only angle corresponding to light of wavelength that is shortest among light of a plurality of colors to the light source element array surface.

12. A hologram display module according to calim 2:
wherein the array comprising a plurality of light source element coherent spatially is comprised by a surface emitting laser array having a Talbot resonator.

13. A hologram display module according to calim 12:
wherein the surface emitting laser array is comprised of a plurality of surface emitting lasers which luminous color is different mutually; and
wherein each of the surface emitting lasers is formed by pattern
that surface emitting lasers area of one color appears in one scanline, or
that surface emitting lasers area of each color appears in one scanline repeatedly.

14. A hologram display module according to calim 2:
wherein erpendicular diffuser plate scattering light in response to each hologram scanline in vertical direction is comprised on the array comprising the spatial light modulation element;
wherein the perpendicular diffuser plate is comprised of a cylindrical lens array (lenticular board) and a shading mask having horizontal slits provided with an emission side of the cylindrical lens;
wherein the perpendicular diffuser plate is comprised of an unidirectional holographic diffuser and a shading mask having horizontal slits provided with an emission side of the cylindrical lens.

15. A three-dimensional display device comprising a plurality of hologram display module described in claim 1,
wherein a display screen placed in vertical direction and/or horizontal direction is comprised.
